(19) United States
(12) Patent Application Publication
(10) Pub. No.: US 2024/0362651 A1
(43) Pub. Date: Oct. 31, 2024

(54) METHOD AND DEVICE FOR VERIFYING OWNERSHIP OF DEEP LEARNING MODEL BASED ON TRAINING PROCESS PROOF, AND MEDIUM

(71) Applicant: TSINGHUA UNIVERSITY, Beijing (CN)

(72) Inventors: Qi LI, Beijing (CN); Yunpeng LIU, Beijing (CN); Ke XU, Beijing (CN); Zhuotao LIU, Beijing (CN)

(21) Appl. No.: 18/644,938

(22) Filed: Apr. 24, 2024

(30) Foreign Application Priority Data
Apr. 25, 2023 (CN) 202310457931.3

(51) Int. Cl. G06Q 30/018

(52) U.S. Cl. CPC G06Q 30/018

(57) ABSTRACT

A computer-implemented method for verifying ownership of a deep learning (DL) model includes: obtaining a Gaussian mixture distribution for initialization of a DL model to be verified, a model chain to be verified of the DL model, and a corresponding verification dataset, wherein the model chain is composed of model parameters of the DL model in each training epoch; calculating, based on the Gaussian mixture distribution, the model chain and the verification dataset, an accuracy monotonicity index, a parameter distance monotonicity index, a parameter distribution continuity index, an initial parameter distribution index, an initial parameter randomness index and a model chain distance index; and obtaining an ownership verification result by determining an authenticity of the model chain based on the accuracy monotonicity index, the parameter distance monotonicity index, the parameter distribution continuity index, the initial parameter distribution index, the initial parameter randomness index and the model chain distance index.

### CROSS-REFERENCE TO RELATED APPLICATIONS

This application claims priority to Chinese Patent Application Serial No. 202310457931.3, filed on Apr. 25, 2023, the entire disclosure of which is incorporated herein by reference.

### TECHNICAL FIELD

The application relates to the field of artificial intelligence (AI) security technology, and more specifically, relates to a method and a device for verifying an ownership of a deep learning model based on a training process proof, and a storage medium.

### BACKGROUND

In recent years, deep learning (DL) technology has developed rapidly and has been applied in a wide range of fields. In practice, training a deep learning model with a high performance requires developers to debug a model structure and hyperparameters for a significant number of times, which inevitably requires a large amount of computing resources and training data resources with high quality. Therefore, DL models have high intellectual property value. However, DL models may be sold to customers in practice, who may illegally publish the models to a third party and infringe upon intellectual property rights of model owners. At the same time, since application scenarios of DL models are complex and diverse, the models of the owners may be obtained illegally by an adversary using attack methods such as a model extraction attack, a side-channel-based model parameter theft.

### SUMMARY

According to a first aspect of the present disclosure, a computer-implemented method for verifying an ownership of a deep learning model based on a training process proof is provided. The method includes: obtaining a Gaussian mixture distribution for initialization of a DL model to be verified, a model chain to be verified of the DL to be verified, and a corresponding verification dataset, in which the model chain to be verified is composed of model parameters of the DL model to be verified in each training epoch; calculating, based on the Gaussian mixture distribution, the model chain to be verified and the verification dataset, an accuracy monotonicity index, a parameter distance monotonicity index, a parameter distribution continuity index, an initial parameter distribution index, an initial parameter randomness index and a model chain distance index of the model chain to be verified; and obtaining an ownership verification result of the DL model to be verified by determining an authenticity of the model chain to be verified based on the accuracy monotonicity index, the parameter distance monotonicity index, the parameter distribution continuity index, the initial parameter distribution index, the initial parameter randomness index and the model chain distance index of the model chain to be verified.

According to a second aspect of the present disclosure, a computer device is provided, which includes a processor, and a memory stored with instructions executable by the processor. The processor is configured to: obtain a Gaussian mixture distribution for initialization of a DL model to be verified, a model chain to be verified of the DL to be verified, and a corresponding verification dataset, in which the model chain to be verified is composed of model parameters of the DL model to be verified in each training epoch; calculate, based on the Gaussian mixture distribution, the model chain to be verified and the verification dataset, an accuracy monotonicity index, a parameter distance monotonicity index, a parameter distribution continuity index, an initial parameter distribution index, an initial parameter randomness index and a model chain distance index of the model chain to be verified; and obtain an ownership verification result of the DL model to be verified by determining an authenticity of the model chain to be verified based on the accuracy monotonicity index, the parameter distance monotonicity index, the parameter distribution continuity index, the initial parameter distribution index, the initial parameter randomness index and the model chain distance index of the model chain to be verified.

According to a third aspect of the present disclosure, a non-transitory computer readable storage medium having computer programs stored thereon is provided. When the computer programs are executed by a computing device, a method for verifying an ownership of a deep learning model based on a training process proof is implemented as described in the first aspect of the disclosure.

The additional aspects and advantages of the disclosure may be partially provided in the following description, which may become apparent from the following description or learned through the practice of the disclosure.

### BRIEF DESCRIPTION OF THE DRAWINGS

The above-mentioned and/or additional aspects and advantages of the disclosure will become apparent and easy to understand from the description of the embodiments in conjunction with the accompanying drawings.

FIG. 1 is a flowchart illustrating a method for verifying an ownership of a DL model based on a training process proof according to an embodiment of the disclosure.

FIG. 2 is a framework diagram illustrating an ownership verification of a DL model based on a training process proof according to an embodiment of the disclosure.

FIG. 3 is a structure diagram illustrating an apparatus for verifying an ownership of a deep learning model based on a training process proof according to an embodiment of the disclosure.

### DETAILED DESCRIPTION

The following describes in detail the embodiments of the disclosure, examples of which are shown in the accompanying drawings, throughout which identical or similar labels represent identical or similar components or components with identical or similar functions. The embodiments described below with reference to the accompanying drawings are exemplary and intended to explain the disclosure, but cannot be understood as limitations to the disclosure.

The method and apparatus for verifying an ownership of a deep learning model based on a training process proof according to embodiments of the disclosure are described in below with reference to the accompanying drawings.

Facing potential infringements on the intellectual property rights of the models, designing an ownership verification algorithm for a DL model may determine whether a model holder owns the model, thereby providing an ownership proof for a true owner of the model and protecting the intellectual property right of the model. An adversary does not have the ownership proof of the illegally obtained model and cannot prove the ownership of the model in an intellectual property dispute. To address real-world security and availability issues, the verification algorithm needs to meet the following requirements: (1) model intactness: the verification algorithm should not have a significant impact on the functionality of the model itself; (2) robustness: an adversary cannot invalidate an ownership proof of a real owner of a model; and (3) exclusiveness: after illegally obtaining the model, an adversary cannot forge a corresponding ownership proof that can pass the verification.

Existing model ownership verification algorithms may be mainly divided into two types, i.e., model watermarking and model fingerprint. In the first type, digital signatures are written into a parameter distribution and an activation value distribution of the model, or a backdoor function is embedded into an output of the model as an ownership proof of the model owner. This requires modifying a training objective function, fine-tuning the model, and other operations to embed additional information, which results in a loss of model performance. In the second type, decision boundary information such as adversarial examples of the model is extracted as the ownership proof without affecting the model performance.

For the model ownership verification algorithm, an adversary may launch adversarial attacks in the following two ways: destroying the ownership proof of the model owner, and forging the ownership proof of the model. In examples of the first way, an adversary may remove watermark information embedded in the model by a trainer/an owner or change a decision boundary of the model by fine-tuning the model, parameter clipping, adversarial training, etc., so that the model fingerprint extracted by the owner is caused to be invalid. In examples of the second way, an adversary may use an algorithm to embed a new watermark into the model or extract model decision boundary fingerprint information as the ownership proof of the illegally obtained model.

The existing model ownership verification algorithms based on the model watermarking and the model fingerprint cannot ensure that model ownership may still be accurately and effectively verified when the above attacks occur. In other words, the technical problem in the related art is that the existing methods for verifying a model ownership cannot ensure accurate and effective verification of the model ownership under destruction and forgery attacks to the ownership proof.

In order to solve the above technical problem in the related art, the disclosure is to propose a method for verifying an ownership of a deep learning model based on a training process proof. By using model chain generated during a DL model training process as a proof of the training process, it may provide an ownership proof of a model without embedding additional information into the model that affects the performance, and perform ownership verification based on basic properties of the model chain, which meets the requirements (i.e., model intactness, robustness, and exclusiveness) for a model verification algorithm. The ownership proof may still be accurately verified under possible destruction and forgery attacks to the ownership proof. The disclosure is suitable for DL models with different structures and tasks and it has a wide range of applications. The loss of model performance cannot be caused, the model is difficult to be attacked by an adversary, and the intellectual property of model owners may be effectively protected.

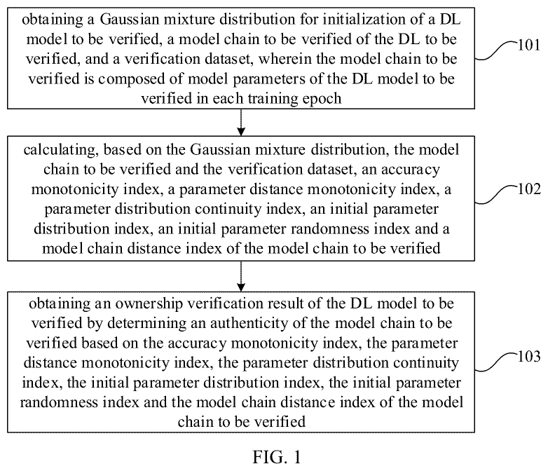

As shown in FIG. 1, the method for verifying an ownership of a deep learning model based on a training process proof includes the following steps at 101-104.

At 101, a Gaussian mixture distribution for initialization of a DL model to be verified, a model chain to be verified of the DL to be verified, and a corresponding verification dataset are obtained. The model chain to be verified is composed of model parameters of the DL model to be verified in each training epoch.

At 102, an accuracy monotonicity index, a parameter distance monotonicity index, a parameter distribution continuity index, an initial parameter distribution index, an initial parameter randomness index and a model chain distance index of the model chain to be verified are calculated based on the Gaussian mixture distribution, the model chain to be verified and the verification dataset.

At 103, an authenticity of the model chain to be verified is determined based on the accuracy monotonicity index, the parameter distance monotonicity index, the parameter distribution continuity index, the initial parameter distribution index, the initial parameter randomness index and the model chain distance index of the model chain to be verified, to obtain an ownership verification result of the DL model to be verified.

According to the method for verifying an ownership of a DL model based on a training process proof in the embodiment of the disclosure, the Gaussian mixture distribution used for initialization of the DL model to be verified, the model chain to be verified of the DL model to be verified, and the corresponding verification dataset are obtained, in which the model chain to be verified is composed of model parameters of the DL model to be verified in each training epoch; the accuracy monotonicity index, the parameter distance monotonicity index, the parameter distribution continuity index, the initial parameter distribution index, the initial parameter randomness index and the model chain distance index of the model chain to be verified are calculated based on the Gaussian mixture distribution, the model chain to be verified and the verification dataset; the authenticity of the model chain to be verified is judged based on the accuracy monotonicity index, the parameter distance monotonicity index, the parameter distribution continuity index, the initial parameter distribution index, the initial parameter randomness index and the model chain distance index of the model chain to be verified, to obtain the ownership verification result of the DL model to be verified. As a result, the technical problem may be solved that the existing methods for a model ownership verification cannot ensure that the model ownership can be accurately and effectively verified under destruction and forgery attacks to the ownership proof. By using model chain generated during a DL model training process as a proof of the training process, it may provide an ownership proof of a model without embedding additional information into the model that affects the performance, and perform ownership verification based on basic properties of the model chain, which meets the requirements (i.e., model intactness, robustness, and exclusiveness) for a model verification algorithm. The ownership proof may still be accurately verified under possible destruction and forgery attacks to the ownership proof. The disclosure is suitable for DL models with different structures and tasks and it has a wide range of applications. The loss of model performance cannot be caused, the model is difficult to be attacked by an adversary, and the intellectual property of model owners may be effectively protected.

A solution for verifying an ownership of a DL model based on a training process proof is proposed. The model chain generated during a DL model training process as a proof of the training process, it may provide an ownership proof of a model without embedding additional information into the model that affects the performance, and perform ownership verification based on basic properties of the model chain. The method includes the following steps: 1) a model owner uses a Gaussian mixture distribution to initialize model parameters and uses a L2 regularization term during the training process, and saves current model parameters in each training epoch to form model chain; 2) a verifier verifies authenticity of the model chain to determine a model ownership. The verifying step includes determining a monotonicity of an intermediate model verification accuracy, a monotonicity of a distance from the intermediate model parameters to final model parameters, a continuity of a parameter distribution in the model chain, a distribution of initial model parameters, a randomness of the initial model parameters, and a distance between an initial model and a final model. The ownership judgment is made based on the above properties. The verification solution proposed in the disclosure has a wide range of applications, will not cause a loss of model performance, is difficult to be attacked by an adversary, and may effectively protect intellectual property rights of model owners.

Before obtaining the Gaussian mixture distribution for initialization of the DL model to be verified, the model chain to be verified of the DL model to be verified, and the corresponding verification dataset, a model training method executed by a model training end to generate a model ownership proof includes the following steps:
1-1) The model training end randomly initializes parameters of each layer of the model according to the Gaussian mixture distribution.
1-2) The model training end uses a gradient descent algorithm to perform a training task of the DL model, uses the L2 regularization term on an objective function of gradient descent training, and saves current intermediate model parameters Cᵢ in each training epoch of the model to obtain the model chain [symbol] =C₁, C₂, . . . , C_{N} in each training epoch, where N is a total number of training epochs. The model chain [symbol] is kept in secret by the model owner as the ownership proof of the trained model.

The model ownership verification algorithm executed by an ownership verifier includes the following steps:
2-1) The verifier obtains the model chain [symbol] to be verified generated in step 1-2) and obtains the verification dataset Dᵥₐₗ corresponding to functions of the model to be verified from a public domain according to a task type.
2-2) The verifier calculates the accuracy of a model in the model chain [symbol] on the verification dataset in turn, calculates a Pearson correlation coefficient ρ_{acc} between the accuracy and the training epoch as the accuracy monotonicity index, and compares ρ_{acc} with a preset threshold δ₁. If ρ_{acc}<δ₁, the model chain is considered to be incoherent/forged.

Specifically, the accuracy monotonicity index is calculated as follows:

$${ρ}_{acc} = 1 - \frac{6 \times {\sum }_{i}^{N} {( rank ( acc ( {C}_{i} , {D}_{val} ) ) - i )}^{2}}{N ( {N}^{{}_{2}} - 1 )}$$

where ρ_{acc} represents the accuracy monotonicity index, N represents a total number of epochs, the function rank(·) represents a ranking of an accuracy of an intermediate model in the model chain, and acc(Cᵢ, Dᵥₐₗ) represents an accuracy of an i-th intermediate model on the validation dataset.
2-3) The verifier calculates a Pearson correlation coefficient ρ_{dis} between a parameter distance from a model in the model chain to the final model C_{N} and the training epoch as the parameter distance monotonicity index, and compares ρ_{dis} with a preset threshold δ₂. If ρ_{dis}<δ₂, the model chain is considered to be incoherent.

Specifically, the parameter distance monotonicity index is calculated as follows:

$${ρ}_{dis} = \vert 1 - \frac{6 \times {\sum }_{i}^{N} {( rank ( d ( {C}_{i} , {C}_{N} ) ) - i )}^{2}}{N ( {N}^{{}_{2}} - 1 )} \vert$$

where ρ_{dis} represents the parameter distance monotonicity index, N represents a total number of epochs, rank(d(Cᵢ, C_{N})) represents a ranking of an Euclidean distance of parameters from the intermediate model to the converged model in a model chain to be verified, and d( [symbol] ) is an Euclidean distance of parameters between the two models.
2-4) The verifier calculates the parameter distribution distance c_{weight} between two consecutive models in the model chain as a parameter distribution continuity index, and compares c_{weight} with the preset threshold δ₃. If c_{weight}>δ₃, the model chain is considered to be incoherent.

Specifically, the parameter distribution continuity index is calculated as follows:

$${c}_{weight} = {max}_{i ∈ [ 1 , N - 1 ]} \{ {max}_{l ∈ [ 1 , L ]} \{ EMD ( P ( {w}_{l}^{i} ) , P ( {w}_{l}^{i + 1} ) ) \} \}$$

where c_{weight} represents the parameter distribution continuity index, N represents a total number of epochs, L represents a number of layers of the model, wₗⁱ represents a parameter matrix of the l-th layer of the i-th intermediate model, P(·) represents a distribution of parameters, and EMD( [symbol] ) represents an Earth Mover's Distance between two distributions.
2-5) The verifier calculates the parameter distribution distance dᵢₙᵢₜ between parameters of the initial model C₀ in the model chain and the Gaussian mixture distribution required in step 1-1) as the initial parameter distribution index, and compares dᵢₙᵢₜ with a preset threshold δ₄. If dᵢₙᵢₜ>δ₄, the model chain is considered to be incoherent.

Specifically, the initial parameter distribution index is calculated as follows:

$${d}_{init} = {max}_{l ∈ [ 1 , L ]} \{ EMD ( P ( {w}_{l}^{0} ) , {P}_{GMM} ( {w}_{l}^{0} ) ) \}$$

where dᵢₙᵢₜ represents the initial parameter distribution index, L represents a number of layers of the model, EMD( [symbol] ) represents an Earth Mover's Distance between the two distributions, P(·) represents a distribution of parameters, wₗⁱ represents a parameter matrix of the l-th layer of the initial model, and P_{GMM} (·) represents a parameter distribution specified in step 1-1).
2-6) The verifier calculates a randomness degree ρ_{pca} of the parameters of the initial model C₀ in the model chain as the initial parameter randomness index, and compares ρ_{pca} with a threshold δ₅ calculated based on sampling. If ρ_{pca}>δ₅, the model chain is considered to be incoherent.

Specifically, the initial parameter randomness index ρ_{pca} is calculated by calculating a variance proportion of a maximum principal component in principal component analysis results of each layer of parameters; the threshold δ₅ is calculated by randomly sampling a plurality of initial models according to the model initialization method in step 1-1) and calculating an average value μ and a standard deviation σ of the initial parameter randomness index ρ_{pca}, then δ₅=μ+10σ.
2-7) The verifier calculates the distance d_{chain} between the initial model C₀ and the final model C_{N} in the model chain as the model chain distance index, and compares d_{chain} with the calculated threshold δ₆. If d_{chain}>56, the model chain is considered to be incoherent.

Specifically, the model chain distance index is calculated as follows:

$${d}_{chain} = d ( {C}_{0} , {C}_{N} )$$

where d_{chain}, represents the model chain distance index, and d(C₀, C_{N}) represents an Euclidean distance of parameters between the initial model C₀ and the converged model C_{N} in the model chain to be verified.

The threshold δ₆ is calculated by randomly sampling a plurality of initial models according to the model initialization method in step 1-1) and calculating the average μ and standard deviation σ of the distances between the initial models and C_{N}, then δ₆=μ−30σ.
2-8) The verifier makes a judgment based on the verification results at steps 2-2) to 2 7). If any step is judged to be incoherent, the model chain to be verified is ultimately considered to be incoherent and the holder does not have a legal ownership of the model. Otherwise, it is considered to be authentic/coherent and the holder has the ownership of the model.

The features and beneficial effects of the disclosure include: (1) verifying the ownership is performed based on the properties of the model chain naturally generated during the DL model training process in terms of the accuracy, the parameter distance, the parameter distribution, the initial parameter characteristics, etc. The model chain is used as a proof of the training process, without a need to embed additional information into the model, so there is no loss of model performance, and the model intactness requirements are met. At the same time, the solution is applicable to DL models with various tasks and has a wide range of applications. (2) By using the model chain as the proof of model ownership, the model owner may keep the proof of ownership in secret and prevent an adversary from maliciously destroying the proof of ownership, which meets the robustness requirement for the model ownership verification. However, the ownership proof of existing model watermarks, fingerprints, etc. are present inside the model and may be destroyed and erased by an adversary who steal the model. (3) The ownership verification is performed by using a plurality of properties of the model chain at different levels. It is difficult for an adversary to forge all properties at the same time when forging the model chain in a model ownership forgery attack. However, the model chain generated by a real training must satisfy all properties at the same time, thus ensuring that the adversary cannot forge the model ownership and meeting the exclusiveness requirement.

In summary, the disclosure provides a general framework of verifying an ownership of the DL model that may maintain the accuracy of verification in possible ownership attacks, meets the requirements for model intactness, robustness, and exclusiveness, and has a wide range of applications.

Further, in an embodiment of the disclosure, calculating, based on the Gaussian mixture distribution, the model chain to be verified and the verification dataset, the accuracy monotonicity index, the parameter distance monotonicity index, the parameter distribution continuity index, the initial parameter distribution index, the initial parameter randomness index and the model chain distance index of the model chain to be verified, includes:
calculating, based on the model chain to be verified and the verification dataset, an accuracy of each model in the model chain to be verified on the verification dataset in sequence, and calculating a Pearson correlation coefficient between the accuracy and the training epoch as the accuracy monotonicity index;
calculating a parameter distance between a model in the model chain to be verified and a converged model, and calculating a Pearson correlation coefficient between the parameter distance and the training epoch as the parameter distance monotonicity index, in which the converged model is a final model in the model chain to be verified;
obtaining the parameter distribution continuity index by calculating a parameter distribution distance between two consecutive models in the model chain to be verified in sequence;
obtaining the initial parameter distribution index by calculating a parameter distribution distance between an initial model in the model chain to be verified and the Gaussian mixture distribution;
obtaining the initial parameter randomness index by calculating a randomness of parameters of the initial model in the model chain to be verified; and
obtaining the model chain distance index by calculating a parameter distance between the initial model and the converged model in the model chain to be verified.

Furthermore, in the embodiment of the disclosure, the accuracy monotonicity index is calculated as follows:

$${ρ}_{acc} = 1 - \frac{6 \times {\sum }_{i}^{N} {( rank ( acc ( {C}_{i} , {D}_{val} ) ) - i )}^{2}}{N ( {N}^{{}_{2}} - 1 )}$$

where ρ_{acc} represents the accuracy monotonicity index, N represents a total number of training epochs, rank(·) represents a ranking of an accuracy of an intermediate model in the model chain to be verified, acc(Cᵢ, Dᵥₐₗ) represents an accuracy of an i-th intermediate model Cᵢ in the model chain to be verified on the verification dataset, and Dᵥₐₗ represents the verification dataset.

The parameter distance monotonicity index is calculated as follows:

$${ρ}_{dis} = \vert 1 - \frac{6 \times {\sum }_{i}^{N} {( rank ( d ( {C}_{i} , {C}_{N} ) ) - i )}^{2}}{N ( {N}^{{}_{2}} - 1 )} \vert$$

where ρ_{dis} represents the parameter distance monotonicity index, N represents the total number of training epochs, rank(·) represents a ranking of an Euclidean distance of parameters between the intermediate model and the converged model in the model chain to be verified, and d(Cᵢ, C_{N}) represents an Euclidean distance of parameters between the i-th intermediate model Cᵢ and the converged model C_{N} in the model chain to be verified.

The parameter distribution continuity index is calculated as:

$${c}_{weight} = {max}_{i ∈ [ 1 , N - 1 ]} \{ {max}_{l ∈ [ 1 , L ]} \{ EMD ( P ( {w}_{l}^{i} ) , P ( {w}_{l}^{i + 1} ) ) \} \}$$

where c_{weight} represents the parameter distribution continuity index, N represents a total number of training epochs, L represents a number of layers of the model, wₗⁱ represents a parameter matrix of an l-th layer of the i-th intermediate model in the model chain to be verified, P(·) represents a distribution of parameters, and EMD( [symbol] ) represents an Earth Mover's Distance between two distributions.

The initial parameter distribution index is calculated as follows:

$${d}_{init} = {max}_{l ∈ [ 1 , L ]} \{ EMD ( P ( {w}_{l}^{0} ) , {P}_{GMM} ( {w}_{l}^{0} ) ) \}$$

where dᵢₙᵢₜ represents the initial parameter distribution index, L represents a number of layers of the model, EMD( [symbol] ) represents an Earth Mover's Distance between the two distributions, P(·) represents a distribution of parameters, wₗⁱ represents a parameter matrix of the l-th layer of the initial model, and P_{GMM} (·) represents the Gaussian mixture distribution.

The calculation method of the initial parameter randomness index is that, calculating a variance proportion of a maximum principal component in principal component analysis results of each layer of the initial model in the model chain to be verified;

The model chain distance index is calculated as:

d_{chain}=d(C₀,C_{N})

where d_{chain} represents the model chain distance index, and d(C₀, C_{N}) represents an Euclidean distance of parameters between the initial model C₀ and the converged model C_{N} in the model chain to be verified.

Further, in the embodiment of the disclosure, obtaining the ownership verification result of the DL model to be verified by judging the authenticity of the model chain to be verified based on the accuracy monotonicity index, the parameter distance monotonicity index, the parameter distribution continuity index, the initial parameter distribution index, the initial parameter randomness index and the model chain distance index of the model chain to be verified, includes:
determining the authenticity of the model chain to be verified by judging whether each of the accuracy monotonicity index, the parameter distance monotonicity index, the parameter distribution continuity index, the initial parameter distribution index, the initial parameter randomness index and the model chain distance index of the model chain to be verified meets a corresponding threshold;
in response to determining any of the accuracy monotonicity index, the parameter distance monotonicity index, the parameter distribution continuity index, the initial parameter distribution index, the initial parameter randomness index and the model chain distance index is that the model chain to be verified is incoherent, determining the model chain to be verified is incoherent, and a trainer of the DL model does not have an ownership of the DL model to be verified; in response to determining any of the accuracy monotonicity index, the parameter distance monotonicity index, the parameter distribution continuity index, the initial parameter distribution index, the initial parameter randomness index and the model chain distance index is that the model chain to be verified is coherent, determining the model chain to be verified is coherent, and the owner of the DL model has an ownership of the DL model to be verified.

In the embodiment of the disclosure, judgment is made based on the verification results of the accuracy monotonicity index, the parameter distance monotonicity index, the parameter distribution continuity index, the initial parameter distribution index, the initial parameter randomness index and the model chain distance index of the model chain to be verified. If any judgment step is determined to be incoherent, the model chain to be verified is ultimately deemed to be forged and the holder does not have the legal ownership of the model; otherwise, it is deemed to be authentic and the holder has the legal ownership of the model.

Further, in the embodiment of the disclosure, determining the authenticity of the model chain to be verified by judging whether each of the accuracy monotonicity index, the parameter distance monotonicity index, the parameter distribution continuity index, the initial parameter distribution index, the initial parameter randomness index and the model chain distance index of the model chain to be verified meets the corresponding threshold, includes:
in response to the accuracy monotonicity index being less than a first preset threshold, determining that the model chain to be verified is incoherent;
in response to the parameter distance monotonicity index being less than a second preset threshold, determining that the model chain to be verified is incoherent;
in response to the parameter distribution continuity index being greater than a third preset threshold, determining that the model chain to be verified is incoherent;
in response to the initial parameter distribution index being greater than a fourth preset threshold, determining that the model chain to be verified is incoherent;
calculating a fifth threshold value, and in response to the initial parameter randomness index being greater than the fifth threshold value, determining that the model chain to be verified is incoherent; and
calculating a sixth threshold, and in response to the model chain distance index being greater than the sixth threshold, determining that the model chain to be verified is incoherent.

Further, in the embodiment of the disclosure, calculating the fifth threshold includes:
randomly sampling a plurality of initial models by using the Gaussian mixture distribution for random initialization, and calculating parameter randomness indexes of the plurality of initial models; and
calculating an average value and a standard deviation of the parameter randomness indexes of the plurality of initial models, and calculating the fifth threshold based on the average value and the standard deviation of the parameter randomness indexes.

In the embodiment of the disclosure, the fifth threshold is calculated based on the average value μ and the standard deviation σ of the parameter randomness indexes, i.e., δ₅=μ+10σ.

Further, in the embodiment of the disclosure, calculating the sixth threshold includes:
randomly sampling a plurality of initial models by using the Gaussian mixture distribution for random initialization, and calculating an average and a standard deviation of parameter distances between the plurality of initial models and the converged model in the model chain to be verified; and
obtaining the sixth threshold by calculation based on the average value and the standard deviation of the parameter distances between the plurality of initial models and the converged model in the model chain to be verified.

In the embodiment of the disclosure, the sixth threshold is calculated based on the average value μ and the standard deviation σ of the parameter distances between the plurality of initial models and the converged model in the model chain to be verified, i.e., δ₆=μ−30σ.

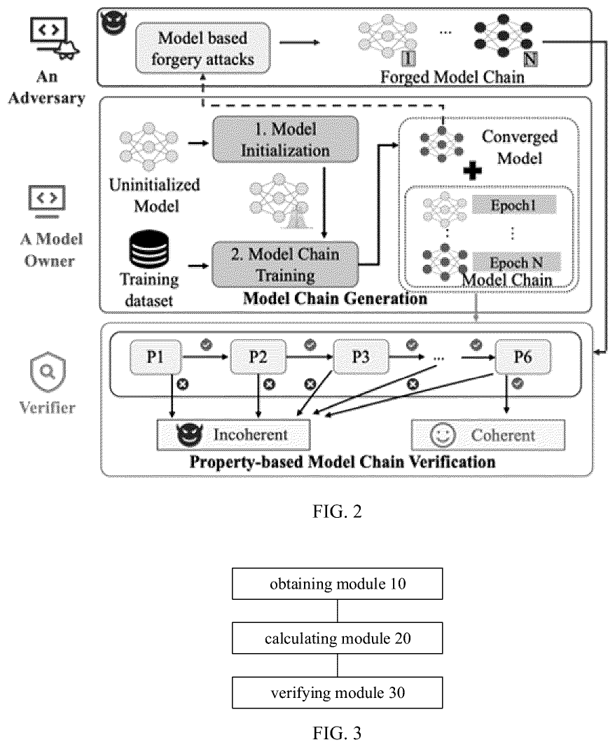

FIG. 2 is a framework diagram illustrating an ownership verification of a DL model based on a training process proof according to an embodiment of the disclosure.

As shown in FIG. 2, the framework for DL model ownership verification includes three entities, among which an owner trains a model and generates a model ownership proof to protect his/her intellectual property right; a potential adversary steals the model trained by the owner and forges the model ownership proof to allege an intellectual property right of the stolen model; a verifier verifies the model ownership proof held by disputing parties when the model ownership dispute arises, so as to identify a legal owner of the model.

The following is a detailed description of a DL model ownership verification solution based on a training process proof proposed in the disclosure.

The model training end performs a model training, which specifically includes:
randomly initializing by the model training end, parameters of each layer of the model based on the Gaussian mixture distribution. This solution is applicable to different types of DL classification tasks and has no specific requirements for a specific data type and a model structure.

In the embodiment of the disclosure, taking an image classification task as an example, the owner collects data of 45,000 CIFAR10 images for model training, using a convolutional neural network (C_{N}N) model structure with 6 convolutional layers. The model parameters are initialized to a Gaussian mixture distribution. Specifically, a distribution of parameters of each layer of the model is a Gaussian mixture distribution containing two components, and an average value and a standard deviation of the two components are

$$\pm 2 \sqrt{2 / 5 {n}_{i n}}$$

and

$$\sqrt{2 / 5 {n}_{i n}} ,$$

respectively, where nᵢₙ is a fan-in size of the layer. For example, if a size of a convolution kernel for a layer of the CNN model is 3*3, there are 64 convolution kernels, and the input contains 3 channels, then the average value of the two components using the Gaussian mixture distribution is

$$\pm 2 \sqrt{2 / ( 5 * 3 * 3 * 3 )} = \pm 2 \sqrt{2 / 135} ,$$

and the standard deviation is

$$\sqrt{2 / ( 5 * 3 * 3 * 3 )} = \sqrt{2 / 135} .$$

After initialization is completed, the model training end uses the gradient descent algorithm to perform a training task of the DL model, uses the L2 regularization term on an objective function of gradient descent training, and saves current intermediate model parameters Cᵢ in each training epoch of the model to obtain the model chain [symbol] =C₁, C₂, . . . , C_{N} in each training epoch, where N is a total number of training epochs.

In the image classification task, N=200, data of 45,000 CIFAR10 images is used for training, the model owner uses a SGD optimizer, a learning rate is 0.1, a L2 regularization coefficient is 0.0001, a batch size of batch training is 128, and the current model parameter values are saved as an intermediate model after each training epoch. The model chain is kept in secret by the model owner as an ownership proof of the trained model.

The verifier verifies the authenticity of the model chain. Considering that an adversary steals the model trained by the owner and uses 5,000 CIFAR10 dataset images outside the training dataset to fine-tune the stolen model to forge a model chain. The specific fine-tuning method is to use a dataset with incorrect labels for training to gradually reduce the model performance and reversely simulate the training process to construct the model chain. At the same time, in order to forge Gaussian mixture distribution properties of the initial model parameters, the adversary randomly samples an initial model that conforms to the Gaussian mixture model distribution as a parameter penalty term in the training process, so that the model is fine-tuned and converged to this model. The adversary initially changed labels of 40% of the images in his dataset to incorrect labels, and increased an incorrect label rate by 10% every 10 training epochs. The adversary used the SGD optimizer for optimization, set the learning rate to 0.1, and performed 100 epochs of model fine-tuning. Finally, he constructed a model chain containing 100 models.

The verifier verifies authenticity of model chains from the owner and the adversary. During the verification process, 10,000 CIFAR10 dataset images outside the training dataset are used as a verification dataset Dᵥₐₗ. During a specific verification process, the verifier calculates indexes of the model chain at different levels such as the accuracy, the parameter distribution, the parameter distance, the parameter randomness, etc. and determines whether each index meets the corresponding condition, thereby determining the authenticity of the model chain.

First, the verifier calculates the accuracy of a model in each model chain on the verification dataset Dᵥₐₗ, and calculates a Pearson correlation coefficient ρ_{acc} between the accuracy and a number of training epochs as the accuracy monotonicity index, and compares ρ_{acc} with a preset threshold δ₁=0.5. If ρ_{acc}<δ₁, the model chain is considered to be incoherent.

Specifically, the accuracy monotonicity index is calculated as follows:

$${ρ}_{acc} = 1 - \frac{6 \times {\sum }_{i}^{N} {( rank ( acc ( {C}_{i} , {D}_{val} ) ) - i )}^{2}}{N ( {N}^{{}_{2}} - 1 )}$$

where ρ_{acc} represents the accuracy monotonicity index, N represents a total number of training epochs, rank(·) represents a ranking of an accuracy of an intermediate model in the model chain, acc(Cᵢ, Dᵥₐₗ) represents an accuracy of an i-th intermediate model Cᵢ in the model chain on the verification dataset.

In this embodiment, the accuracy monotonicity index of a real model chain for the owner is equal to 0.9256, i.e., ρ_{acc}=0.9256, and the accuracy monotonicity index of a forged model chain for the adversary is equal to 0.6184, i.e., ρ_{acc}=0.6184, both of which simultaneously meet the threshold value δ₁.

Next, the verifier calculates a Pearson correlation coefficient ρ_{dis} between a parameter distance from a model in each model chain to the final model C_{N} and the training epoch, as the parameter distance monotonicity index, and compares ρ_{dis} with the preset threshold δ₂ (which is equal to 0.8). If ρ_{dis}<δ₂, the model chain is considered to be incoherent.

Specifically, the parameter distance monotonicity index is calculated as follows:

$${ρ}_{dis} = \vert 1 - \frac{6 \times {\sum }_{i}^{N} {( rank ( d ( {C}_{i} , {C}_{N} ) ) - i )}^{2}}{N ( {N}^{2} - 1 )} \vert$$

where ρ_{dis} represents the parameter distance monotonicity index, N represents the total number of training epochs, rank(d(Cᵢ, C_{N})) represents a ranking of an Euclidean distance of parameters from the intermediate model to the converged model in a model chain to be verified, and d( [symbol] ) is an Euclidean distance of parameters between two models.

In the embodiment, the parameter distance monotonicity index of the real model chain for owner is equal to 0.9919, i.e., P_{dis}=0.9919, and the parameter distance monotonicity index of the forged model chain is equal to 0.9783, i.e., P_{dis}=0.9783, both of which simultaneously meet the threshold condition.

Next, the verifier calculates the parameter distribution distance c_{weight} between two consecutive models in each model chain as the parameter distribution continuity index, and compares c_{weight} with the preset threshold δ₃ (which is equal to 0.8). If c_{weight}>δ₃, the model chain is considered to be incoherent.

Specifically, the parameter distribution continuity index is calculated as follows:

$${c}_{weight} = {max}_{i ∈ [ 1 , N - 1 ]} \{ {max}_{l ∈ [ 1 , L ]} \{ EMD ( P ( {w}_{l}^{i} ) , P ( {w}_{l}^{i + 1} ) ) \} \}$$

where c_{weight} represents the parameter distribution continuity index, N represents a total number of epochs, L represents a number of layers of the model, wₗⁱ represents a parameter matrix of the l-th layer of the i-th intermediate model, P(·) represents a distribution of parameters, and EMD( [symbol] ) represents an Earth Mover's Distance between two distributions.

In this embodiment, the parameter distribution continuity index of the real model chain for the owner is equal to 0.2719, i.e., c_{weight}=0.2719 and the parameter distribution continuity index of the forged model chain for the adversary is equal to 1.2691, i.e., c_{weight}=1.2691. the forged model chain does not meet the requirement for the parameter distribution continuity index.

Next, the verifier calculates the parameter distribution distance dᵢₙᵢₜ between the parameters of the initial model C₀ in each model chain and the Gaussian mixture distribution required in the training process as the initial parameter distribution index, and compares dints with the preset threshold δ₄ (which is equal to 0.3). If dᵢₙᵢₜ>δ₄, the model chain is considered to be incoherent.

Specifically, the initial parameter distribution index is calculated as follows:

$${d}_{init} = {max}_{l ∈ [ 1 , L ]} \{ EMD ( P ( {w}_{l}^{0} ) , {P}_{GMM} ( {w}_{l}^{0} ) ) \}$$

where dᵢₙᵢₜ represents the initial parameter distribution index, L represents a number of layers of the model, EMD ( [symbol] ) represents an Earth Mover's Distance between the two distributions, P(·) represents a distribution of parameters, wₗ⁰ represents a parameter matrix of the l-th layer of the initial model, and P_{GMM} (·) represents a parameter distribution specified in step 1-1).

In this embodiment, the initial parameter distribution index of the real model chain for the owner is equal to 0.1097, i.e., dᵢₙᵢₜ=0.1367 and the initial parameter distribution index of the forged model chain for the adversary is equal to 0.1367, i.e., dᵢₙᵢₜ=0.1367. Both of the model chains meet the threshold condition.

Next, the verifier calculates a randomness degree P_{pca} of the parameters of the initial model C₀ in each model chain as the initial parameter randomness index, and compares P_{pca} with a threshold δ₅ calculated based on sampling. If ρ_{pca}>δ₅, the model chain is considered to be incoherent.

Specifically, the initial parameter randomness index P_{pca} is calculated by calculating a variance proportion of a maximum principal component in principal component analysis results of each layer of parameters; the threshold δ₅ is calculated by randomly sampling a plurality of initial models according to the model initialization method in the model training process and calculating an average value μ and a standard deviation σ of the initial parameter randomness index P_{pca}, then δ₅=μ+10σ.

In the embodiment, the initial model is sampled for 100 times, and μ=0.1537, σ=0.0065 are calculated, and the calculated threshold value is 0.2187, i.e., δ₅=0.2187. P_{pca} of the real model chain for the owner is equal to 0.1575 (i.e., P_{pca}=0.1575), and P_{pca} of the forged model chain for the adversary is equal to 0.1653 (i.e., P_{pca}=0.1653), both of which meet the threshold condition.

Next, the verifier calculates the distance d_{chain} between the initial model C₀ and the final model C_{N} in the model chain as the model chain distance index, and compares d_{chain} with the calculated threshold δ₆. If d_{chain}>δ₆, the model chain is considered to be incoherent.

Specifically, the model chain distance index is calculated as follows:

$${d}_{chain} = d ( {C}_{0} , {C}_{N} )$$

where d_{chain} represents the model chain distance index, and d(C₀, C_{N}) represents an Euclidean distance of parameters between the initial model C₀ and the converged model C_{N} in the model chain to be verified. The threshold δ₆ is calculated by randomly sampling a plurality of initial models according to the model initialization method in the model training process and calculating the average μ and standard deviation σ of the distances between the initial models and C_{N}, then δ₆=μ−30σQ.

In the embodiment, the initial model is sampled for 100 times, μ=3.765×10⁻³ and σ=7.636×10⁻⁶ are calculated, and the calculated threshold value is equal to 3.536×10⁻³. d_{chain} of the real model chain for the owner is equal to 0.0015, d_{chain} of the forged model chain for the adversary is equal to 3.767×10⁻³. The forged model chain for the adversary does not meet the requirement for the model chain distance index.

According to the above index judgment results, the model chain generated by the real training of the owner meets the requirements for all the indexes at the same time and it is thus judged that the model chain of the owner is authentic/coherent via the above verification solution, while the forged model chain of the adversary does not meet the requirements for the parameter distribution continuity index and the model chain distance index, and it is thus judged that the model chain of the adversary is forged/incoherent via the above verification solution.

FIG. 3 is a structure diagram illustrating an apparatus for verifying an ownership of a deep learning model based on a training process proof according to an embodiment of the disclosure.

As shown in FIG. 3, the apparatus for verifying an ownership of a deep learning model based on a training process proof includes: an obtaining module 10, a calculating module 20 and a verifying module 30.

The obtaining module 10 is configured to obtain a Gaussian mixture distribution for initialization of a DL model to be verified, a model chain to be verified of the DL to be verified, and a corresponding verification dataset, in which the model chain to be verified is composed of model parameters of the DL model to be verified in each training epoch.

The calculating module 20 is configured to calculate, based on the Gaussian mixture distribution, the model chain to be verified and the verification dataset, an accuracy monotonicity index, a parameter distance monotonicity index, a parameter distribution continuity index, an initial parameter distribution index, an initial parameter randomness index and a model chain distance index of the model chain to be verified.

The verifying module 30 is configured to obtain an ownership verification result of the DL model to be verified by determining an authenticity of the model chain to be verified based on the accuracy monotonicity index, the parameter distance monotonicity index, the parameter distribution continuity index, the initial parameter distribution index, the initial parameter randomness index and the model chain distance index of the model chain to be verified.

According to the apparatus for verifying an ownership of a DL model based on a training process proof in the embodiment of the disclosure, the obtaining module, the calculating module and the verifying module are included. The obtaining module is configured to obtain a Gaussian mixture distribution for initialization of a DL model to be verified, a model chain to be verified of the DL to be verified, and a corresponding verification dataset, in which the model chain to be verified is composed of model parameters of the DL model to be verified in each training epoch. The calculating module is configured to calculate, based on the Gaussian mixture distribution, the model chain to be verified and the verification dataset, an accuracy monotonicity index, a parameter distance monotonicity index, a parameter distribution continuity index, an initial parameter distribution index, an initial parameter randomness index and a model chain distance index of the model chain to be verified. The verifying module is configured to obtain an ownership verification result of the DL model to be verified by determining an authenticity of the model chain to be verified based on the accuracy monotonicity index, the parameter distance monotonicity index, the parameter distribution continuity index, the initial parameter distribution index, the initial parameter randomness index and the model chain distance index of the model chain to be verified. As a result, the technical problem may be solved that the existing methods for a model ownership verification cannot ensure that the model ownership can be accurately and effectively verified under destruction and forgery attacks to the ownership proof. By using model chain generated during a DL model training process as a proof of the training process, it may provide an ownership proof of a model without embedding additional information into the model that affects the performance, and perform ownership verification based on basic properties of the model chain, which meets the requirements (i.e., model intactness, robustness, and exclusiveness) for a model verification algorithm. The ownership proof may still be accurately verified under possible destruction and forgery attacks to the ownership proof. The disclosure is suitable for DL models with different structures and tasks and it has a wide range of applications. The loss of model performance cannot be caused, the model is difficult to be attacked by an adversary, and the intellectual property of model owners may be effectively protected.

In order to implement the above embodiments, the disclosure also proposes a computer device, including a memory, a processor, and a computer program stored in the memory and executable by the processor. When the computer program is executed by the processor, the method for verifying an ownership of a DL model based on a training process proof described in the above embodiments is implemented.

In order to implement the above-mentioned embodiments, the disclosure also proposes a non-transitory computer-readable storage medium on which a computer program is stored. When the computer program is executed by a processor, the method for verifying an ownership of a DL model based on a training process proof described in the above embodiments is implemented.

In the descriptions of this specification, the descriptions with reference to the terms “an embodiment”, “some embodiments”, “example”, “specific example”, or “some examples” etc. means that the specific features, structures, materials or characteristics described in conjunction with the embodiment or example are included in at least one embodiment or example of the disclosure. In the present specification, the exemplary expressions of the above terms do not necessarily refer to the same embodiment or example. Furthermore, the specific features, structures, materials, or characteristics described may be combined in any suitable manner in any one or more embodiments or examples. Furthermore, those skilled in the art may combine and associate different embodiments or examples and features of different embodiments or examples described in this specification without conflicting from each other.

In addition, the terms “first” and “second” are used for descriptive purposes only and should not be understood as indicating or implying the relative importance or implicitly indicating the quantity of the indicated technical features. Therefore, the features defined as “first” or “second” may explicitly or implicitly include at least one of the features. In the description of the disclosure, “a plurality of” means at least two, for example, two, three, etc., unless otherwise clearly and specifically defined.

Any process or method description in a flowchart or otherwise described herein may be understood to represent a module, fragment or portion of codes including one or more executable instructions for implementing the steps of a custom logical function or process, and the scope of preferred embodiments of the disclosure includes alternative implementations in which functions may not be performed in the order shown or discussed, in which functions are performed in a substantially simultaneous manner or in reverse order depending on the functions involved, which should be understood by those skilled in the art to which the embodiments of the disclosure belong.

The logic and/or steps represented in the flowchart or otherwise described herein, for example, may be considered as an ordered list of executable instructions for implementing logical functions, which may be embodied in any computer-readable medium for use by an instruction execution system, apparatus or device (such as a computer-based system, a system including a processor or other system that may fetch instructions from an instruction execution system, apparatus or device and execute the instructions), or used in combination with the instruction execution system, apparatus or device. For the purposes of this specification, a “computer-readable medium” may be any device that may contain, store, communicate, propagate or transport the program for use by an instruction execution system, apparatus or device or in conjunction with such instruction execution system, apparatus or device. More specific examples (a non-exhaustive list) of computer-readable media include the following: an electrical connection having one or more wires (electronic device), a portable computer disk case (magnetic device), a random access memory (RAM), a read-only memory (ROM), an erasable and programmable read-only memory (EPROM or a flash memory), a fiber optic device, and a portable compact disk read-only memory (CDROM). In addition, the computer-readable medium may even be paper or other suitable medium on which the program is printed, since the program may be obtained electronically, for example, by optically scanning the paper or other medium and editing, interpreting or processing in other suitable ways if necessary, and may be then stored in a computer memory.

It should be understood that various parts of the disclosure may be implemented in hardware, software, firmware or their combination. In the above embodiments, a plurality of steps or methods may be implemented in software or firmware stored in a memory and executed by a suitable instruction execution system. For example, if implemented in hardware, as in another embodiment, it may be implemented using any one of the following technologies known in the art or their combination: a discrete logic circuit having a logic gate circuit for implementing a logic function on a data signal, a dedicated integrated circuit having a suitable combination of logic gate circuits, a programmable gate array (PGA), a field programmable gate array (FPGA), etc.

Those skilled in the art may understand that all or part of the steps in the method for implementing the above-mentioned embodiment may be completed by instructing related hardware through a program, and the program may be stored in a computer-readable storage medium, which, when executed, includes one or a combination of the steps in the method embodiments.

In addition, each functional unit in each embodiment of the disclosure may be integrated into one processing module, or each unit may exist physically separately, or two or more units may be integrated into one module. The above integrated modules may be implemented in the form of hardware or in the form of software functional modules. If the integrated module is implemented in the form of a software function module and sold or used as an independent product, it may also be stored in a computer-readable storage medium.

The storage medium mentioned above may be a read-only memory, a magnetic disk or an optical disk, etc. Although the embodiments of the disclosure have been shown and described above, it may be understood that the above embodiments are exemplary and cannot be understood as limitations on the disclosure. Those skilled in the art may change, modify, replace and modify the above embodiments within the scope of the disclosure.

What is claimed is:

1. A computer-implemented method for verifying an ownership of a deep learning (DL) model based on a training process proof, comprising:
obtaining a Gaussian mixture distribution for initialization of a DL model to be verified, a model chain to be verified of the DL to be verified, and a verification dataset, wherein the model chain to be verified is composed of model parameters of the DL model to be verified in each training epoch;
calculating, based on the Gaussian mixture distribution, the model chain to be verified and the verification dataset, an accuracy monotonicity index, a parameter distance monotonicity index, a parameter distribution continuity index, an initial parameter distribution index, an initial parameter randomness index and a model chain distance index of the model chain to be verified; and
obtaining an ownership verification result of the DL model to be verified by determining an authenticity of the model chain to be verified based on the accuracy monotonicity index, the parameter distance monotonicity index, the parameter distribution continuity index, the initial parameter distribution index, the initial parameter randomness index and the model chain distance index of the model chain to be verified.

2. The method of claim 1, wherein calculating the accuracy monotonicity index, the parameter distance monotonicity index, the parameter distribution continuity index, the initial parameter distribution index, the initial parameter randomness index and the model chain distance index of the model chain to be verified, comprises:
calculating, based on the model chain to be verified and the verification dataset, an accuracy of each model in the model chain to be verified on the verification dataset in sequence, and calculating a Pearson correlation coefficient between the accuracy and the training epoch as the accuracy monotonicity index;
calculating a parameter distance between a model in the model chain to be verified and a converged model, and calculating a Pearson correlation coefficient between the parameter distance and the training epoch as the parameter distance monotonicity index, wherein the converged model is a final model in the model chain to be verified;
obtaining the parameter distribution continuity index by calculating a parameter distribution distance between two consecutive models in the model chain to be verified in sequence;
obtaining the initial parameter distribution index by calculating a parameter distribution distance between an initial model in the model chain to be verified and the Gaussian mixture distribution;
obtaining the initial parameter randomness index by calculating a randomness of parameters of the initial model in the model chain to be verified; and
obtaining the model chain distance index by calculating a parameter distance between the initial model and the converged model in the model chain to be verified.

3. The method of claim 2, wherein the accuracy monotonicity index is calculated as:
$${ρ}_{acc} = 1 - \frac{6 \times {\sum }_{i}^{N} {( rank ( acc ( {C}_{i} , {D}_{val} ) ) - i )}^{2}}{N ( {N}^{2} - 1 )}$$
where ρ_{acc} represents the accuracy monotonicity index, N represents a total number of training epochs, rank(·) represents a ranking of an accuracy of an intermediate model in the model chain to be verified, acc(Cᵢ, Dᵥₐₗ) represents an accuracy of an i-th intermediate model Cᵢ in the model chain to be verified on the verification dataset, and Dᵥₐₗ represents the verification dataset;
the parameter distance monotonicity index is calculated as:
$${ρ}_{dis} = \vert 1 - \frac{6 \times {\sum }_{i}^{N} {( rank ( d ( {C}_{i} , {C}_{N} ) ) - i )}^{2}}{N ( {N}^{2} - 1 )} \vert$$
where ρ_{dis} represents the parameter distance monotonicity index, N represents the total number of training epochs, rank(·) represents a ranking of an Euclidean distance of parameters between the intermediate model and the converged model in the model chain to be verified, and d(Cᵢ, C_{N}) represents an Euclidean distance of parameters between the i-th intermediate model Cᵢ and the converged model C_{N} in the model chain to be verified;
the parameter distribution continuity index is calculated as:
$${c}_{weight} = {max}_{i ∈ [ 1 , N - 1 ]} \{ {max}_{l ∈ [ 1 , L ]} \{ EMD ( P ( {w}_{l}^{i} ) , P ( {w}_{l}^{i + 1} ) ) \} \}$$
where c_{weight} represents the parameter distribution continuity index, N represents a total number of training epochs, L represents a number of layers of the model, wₗⁱ represents a parameter matrix of an l-th layer of the i-th intermediate model in the model chain to be verified, P(·) represents a distribution of parameters, and EMD( [symbol] ) represents an Earth Mover's Distance between two distributions;
the initial parameter distribution index is calculated as follows:
$${d}_{init} = {max}_{l ∈ [ 1 , L ]} \{ EMD ( P ( {w}_{l}^{0} ) , {P}_{GMM} ( {w}_{l}^{0} ) ) \}$$
where dᵢₙᵢₜ represents the initial parameter distribution index, L represents a number of layers of the model, EMD( [symbol] ) represents an Earth Mover's Distance between the two distributions, P(·) represents a distribution of parameters, wₗ⁰ represents a parameter matrix of the l-th layer of the initial model, and P_{GMM} (·) represents the Gaussian mixture distribution;
the initial parameter randomness index is calculated by calculating a variance proportion of a maximum principal component in principal component analysis results of each layer of the initial model in the model chain to be verified; and
the model chain distance index is calculated as:
$${d}_{chain} = d ( {C}_{0} , {C}_{N} )$$
where d_{chain} represents the model chain distance index, and d(C₀, C_{N}) represents an Euclidean distance of parameters between the initial model C₀ and the converged model C_{N} in the model chain to be verified.

4. The method of claim 1, wherein obtaining the ownership verification result of the DL model to be verified by determining the authenticity of the model chain to be verified comprises:
determining the authenticity of the model chain to be verified by judging whether each of the accuracy monotonicity index, the parameter distance monotonicity index, the parameter distribution continuity index, the initial parameter distribution index, the initial parameter randomness index and the model chain distance index of the model chain to be verified meets a corresponding threshold;
in response to determining any of the accuracy monotonicity index, the parameter distance monotonicity index, the parameter distribution continuity index, the initial parameter distribution index, the initial parameter randomness index and the model chain distance index is that the model chain to be verified is incoherent, determining the model chain to be verified is incoherent, and a trainer of the DL model does not have an ownership of the DL model to be verified; and
in response to determining any of the accuracy monotonicity index, the parameter distance monotonicity index, the parameter distribution continuity index, the initial parameter distribution index, the initial parameter randomness index and the model chain distance index is that the model chain to be verified is coherent, determining the model chain to be verified is coherent, and the trainer of the DL model has an ownership of the DL model to be verified.

5. The method of claim 4, wherein determining the authenticity of the model chain to be verified by judging whether each of the accuracy monotonicity index, the parameter distance monotonicity index, the parameter distribution continuity index, the initial parameter distribution index, the initial parameter randomness index and the model chain distance index of the model chain to be verified meets the corresponding threshold, comprises:
in response to the accuracy monotonicity index being less than a first preset threshold, determining that the model chain to be verified is incoherent;
in response to the parameter distance monotonicity index being less than a second preset threshold, determining that the model chain to be verified is incoherent;
in response to the parameter distribution continuity index being greater than a third preset threshold, determining that the model chain to be verified is incoherent;
in response to the initial parameter distribution index being greater than a fourth preset threshold, determining that the model chain to be verified is incoherent;
calculating a fifth threshold, and in response to the initial parameter randomness index being greater than the fifth threshold, determining that the model chain to be verified is incoherent; and
calculating a sixth threshold, and in response to the model chain distance index being greater than the sixth threshold, determining that the model chain to be verified is incoherent.

6. The method of claim 5, wherein calculating the fifth threshold comprises:
randomly sampling a plurality of initial models by using the Gaussian mixture distribution for random initialization, and calculating parameter randomness indexes of the plurality of initial models; and
calculating an average value and a standard deviation of the parameter randomness indexes of the plurality of initial models, and calculating the fifth threshold based on the average value and the standard deviation of the parameter randomness indexes.

7. The method of claim 5, wherein calculating the sixth threshold comprises:
randomly sampling a plurality of initial models by using the Gaussian mixture distribution for random initialization, and calculating an average and a standard deviation of parameter distances between the plurality of initial models and a converged model in the model chain to be verified; and
obtaining the sixth threshold by calculation based on an average value and the standard deviation of the parameter distances between the plurality of initial models and the converged model in the model chain to be verified.

8. A computer device, comprising:
a processor, and
a memory stored with instructions executable by the processor,
wherein the processor is configured to:
obtain a Gaussian mixture distribution for initialization of a DL model to be verified, a model chain to be verified of the DL to be verified, and a corresponding verification dataset, wherein the model chain to be verified is composed of model parameters of the DL model to be verified in each training epoch;
calculate, based on the Gaussian mixture distribution, the model chain to be verified and the verification dataset, an accuracy monotonicity index, a parameter distance monotonicity index, a parameter distribution continuity index, an initial parameter distribution index, an initial parameter randomness index and a model chain distance index of the model chain to be verified; and
obtain an ownership verification result of the DL model to be verified by determining an authenticity of the model chain to be verified based on the accuracy monotonicity index, the parameter distance monotonicity index, the parameter distribution continuity index, the initial parameter distribution index, the initial parameter randomness index and the model chain distance index of the model chain to be verified.

9. The computer device of claim 8, wherein the processor is further configured to:
calculate, based on the model chain to be verified and the verification dataset, an accuracy of each model in the model chain to be verified on the verification dataset in sequence, and calculating a Pearson correlation coefficient between the accuracy and the training epoch as the accuracy monotonicity index;
calculate a parameter distance between a model in the model chain to be verified and a converged model, and calculating a Pearson correlation coefficient between the parameter distance and the training epoch as the parameter distance monotonicity index, wherein the converged model is a final model in the model chain to be verified;
obtain the parameter distribution continuity index by calculating a parameter distribution distance between two consecutive models in the model chain to be verified in sequence;
obtain the initial parameter distribution index by calculating a parameter distribution distance between an initial model in the model chain to be verified and the Gaussian mixture distribution;
obtain the initial parameter randomness index by calculating a randomness of parameters of the initial model in the model chain to be verified; and
obtain the model chain distance index by calculating a parameter distance between the initial model and the converged model in the model chain to be verified.

10. The computer device of claim 9, wherein the accuracy monotonicity index is calculated as:
$${ρ}_{acc} = 1 - \frac{6 \times {\sum }_{i}^{N} {( rank ( acc ( {C}_{i} , {D}_{val} ) ) - i )}^{2}}{N ( {N}^{2} - 1 )}$$
where ρ_{acc} represents the accuracy monotonicity index, N represents a total number of training epochs, rank(·) represents a ranking of an accuracy of an intermediate model in the model chain to be verified, acc(Cᵢ, Dᵥₐₗ) represents an accuracy of an i-th intermediate model Cᵢ in the model chain to be verified on the verification dataset, and Dᵥₐₗ represents the verification dataset;
the parameter distance monotonicity index is calculated as:
$${ρ}_{dis} = \vert 1 - \frac{6 \times {\sum }_{i}^{N} {( rank ( d ( {C}_{i} , {C}_{N} ) ) - i )}^{2}}{N ( {N}^{2} - 1 )} \vert$$
where ρ_{dis} represents the parameter distance monotonicity index, N represents the total number of training epochs, rank(·) represents a ranking of an Euclidean distance of parameters between the intermediate model and the converged model in the model chain to be verified, and d(Cᵢ, C_{N}) represents an Euclidean distance of parameters between the i-th intermediate model Cᵢ and the converged model C_{N} in the model chain to be verified;
the parameter distribution continuity index is calculated as:
$${c}_{weight} = {max}_{i ∈ [ 1 , N - 1 ]} \{ {max}_{l ∈ [ 1 , L ]} \{ EMD ( P ( {w}_{l}^{i} ) , P ( {w}_{l}^{i + 1} ) ) \} \}$$
where c_{weight} represents the parameter distribution continuity index, N represents a total number of training epochs, L represents a number of layers of the model, wₗⁱ represents a parameter matrix of an l-th layer of the i-th intermediate model in the model chain to be verified, P(·) represents a distribution of parameters, and EMD( [symbol] ) represents an Earth Mover's Distance between two distributions;
the initial parameter distribution index is calculated as follows:
$${d}_{init} = {max}_{l ∈ [ 1 , L ]} \{ EMD ( P ( {w}_{l}^{0} ) , {P}_{GMM} ( {w}_{l}^{0} ) ) \}$$
where dᵢₙᵢₜ represents the initial parameter distribution index, L represents a number of layers of the model, EMD( [symbol] ) represents an Earth Mover's Distance between the two distributions, P(·) represents a distribution of parameters, wₗ⁰ represents a parameter matrix of the l-th layer of the initial model, and P_{GMM}(·) represents the Gaussian mixture distribution;
the initial parameter randomness index is calculated by calculating a variance proportion of a maximum principal component in principal component analysis results of each layer of the initial model in the model chain to be verified; and
the model chain distance index is calculated as:
$${d}_{chain} = d ( {C}_{0} , {C}_{N} )$$
where d_{chain} represents the model chain distance index, and d(C₀, C_{N}) represents an Euclidean distance of parameters between the initial model C₀ and the converged model C_{N} in the model chain to be verified.

11. The computer device of claim 8, wherein the processor is further configured to:
determine the authenticity of the model chain to be verified by judging whether each of the accuracy monotonicity index, the parameter distance monotonicity index, the parameter distribution continuity index, the initial parameter distribution index, the initial parameter randomness index and the model chain distance index of the model chain to be verified meets a corresponding threshold;
in response to determining any of the accuracy monotonicity index, the parameter distance monotonicity index, the parameter distribution continuity index, the initial parameter distribution index, the initial parameter randomness index and the model chain distance index is that the model chain to be verified is incoherent, determine the model chain to be verified is incoherent, and a trainer of the DL model does not have an ownership of the DL model to be verified; and
in response to determining any of the accuracy monotonicity index, the parameter distance monotonicity index, the parameter distribution continuity index, the initial parameter distribution index, the initial parameter randomness index and the model chain distance index is that the model chain to be verified is coherent, determine the model chain to be verified is coherent, and the trainer of the DL model has an ownership of the DL model to be verified.

12. The computer device of claim 11, wherein the processor is further configured to:
in response to the accuracy monotonicity index being less than a first preset threshold, determine that the model chain to be verified is incoherent;
in response to the parameter distance monotonicity index being less than a second preset threshold, determine that the model chain to be verified is incoherent;
in response to the parameter distribution continuity index being greater than a third preset threshold, determine that the model chain to be verified is incoherent;
in response to the initial parameter distribution index being greater than a fourth preset threshold, determine that the model chain to be verified is incoherent;
calculate a fifth threshold, and in response to the initial parameter randomness index being greater than the fifth threshold, determine that the model chain to be verified is incoherent; and
calculate a sixth threshold, and in response to the model chain distance index being greater than the sixth threshold, determine that the model chain to be verified is incoherent.

13. The computer device of claim 12, wherein the processor is further configured to:
randomly sample a plurality of initial models by using the Gaussian mixture distribution for random initialization, and calculate parameter randomness indexes of the plurality of initial models; and
calculate an average value and a standard deviation of the parameter randomness indexes of the plurality of initial models, and calculate the fifth threshold based on the average value and the standard deviation of the parameter randomness indexes.

14. The computer device of claim 12, wherein the processor is further configured to:
randomly sample a plurality of initial models by using the Gaussian mixture distribution for random initialization, and calculate an average and a standard deviation of parameter distances between the plurality of initial models and a converged model in the model chain to be verified; and
obtain the sixth threshold by calculation based on an average value and the standard deviation of the parameter distances between the plurality of initial models and the converged model in the model chain to be verified.

15. A non-transitory computer readable storage medium having computer programs stored thereon, wherein when the computer programs are executed by a computing device, a method for verifying an ownership of a deep learning (DL) model based on a training process proof is implemented, the method comprising:
obtaining a Gaussian mixture distribution for initialization of a DL model to be verified, a model chain to be verified of the DL to be verified, and a corresponding verification dataset, wherein the model chain to be verified is composed of model parameters of the DL model to be verified in each training epoch;
calculating, based on the Gaussian mixture distribution, the model chain to be verified and the verification dataset, an accuracy monotonicity index, a parameter distance monotonicity index, a parameter distribution continuity index, an initial parameter distribution index, an initial parameter randomness index and a model chain distance index of the model chain to be verified; and
obtaining an ownership verification result of the DL model to be verified by determining an authenticity of the model chain to be verified based on the accuracy monotonicity index, the parameter distance monotonicity index, the parameter distribution continuity index, the initial parameter distribution index, the initial parameter randomness index and the model chain distance index of the model chain to be verified.

16. The storage medium of claim 15, wherein calculating the accuracy monotonicity index, the parameter distance monotonicity index, the parameter distribution continuity index, the initial parameter distribution index, the initial parameter randomness index and the model chain distance index of the model chain to be verified, comprises:
calculating, based on the model chain to be verified and the verification dataset, an accuracy of each model in the model chain to be verified on the verification dataset in sequence, and calculating a Pearson correlation coefficient between the accuracy and the training epoch as the accuracy monotonicity index;
calculating a parameter distance between a model in the model chain to be verified and a converged model, and calculating a Pearson correlation coefficient between the parameter distance and the training epoch as the parameter distance monotonicity index, wherein the converged model is a final model in the model chain to be verified;
obtaining the parameter distribution continuity index by calculating a parameter distribution distance between two consecutive models in the model chain to be verified in sequence;
obtaining the initial parameter distribution index by calculating a parameter distribution distance between an initial model in the model chain to be verified and the Gaussian mixture distribution;
obtaining the initial parameter randomness index by calculating a randomness of parameters of the initial model in the model chain to be verified; and
obtaining the model chain distance index by calculating a parameter distance between the initial model and the converged model in the model chain to be verified.

17. The storage medium of claim 16, wherein the accuracy monotonicity index is calculated as:
$${ρ}_{acc} = 1 - \frac{6 \times {\sum }_{i}^{N} {( rank ( acc ( {C}_{i} , {D}_{val} ) ) - i )}^{2}}{N ( {N}^{2} - 1 )}$$
where ρ_{acc} represents the accuracy monotonicity index, N represents a total number of training epochs, rank(·) represents a ranking of an accuracy of an intermediate model in the model chain to be verified, acc(Cᵢ, Dᵥₐₗ) represents an accuracy of an i-th intermediate model Cᵢ in the model chain to be verified on the verification dataset, and Dᵥₐₗ represents the verification dataset;
the parameter distance monotonicity index is calculated as:
$${ρ}_{dis} = \vert 1 - \frac{6 \times {\sum }_{i}^{N} {( rank ( d ( {C}_{i} , {C}_{N} ) ) - i )}^{2}}{N ( {N}^{2} - 1 )} \vert$$
where ρ_{dis} represents the parameter distance monotonicity index, N represents the total number of training epochs, rank(·) represents a ranking of an Euclidean distance of parameters between the intermediate model and the converged model in the model chain to be verified, and d(Cᵢ, C_{N}) represents an Euclidean distance of parameters between the i-th intermediate model Cᵢ and the converged model C_{N} in the model chain to be verified;
the parameter distribution continuity index is calculated as:
$${c}_{weight} = {max}_{i ∈ [ 1 , N - 1 ]} \{ {max}_{l ∈ [ 1 , L ]} \{ EMD ( P ( {w}_{l}^{i} ) , P ( {w}_{l}^{i + 1} ) ) \} \}$$
where c_{weight} represents the parameter distribution continuity index, N represents a total number of training epochs, L represents a number of layers of the model, wₗⁱ represents a parameter matrix of an l-th layer of the i-th intermediate model in the model chain to be verified, P(·) represents a distribution of parameters, and EMD( [symbol] ) represents an Earth Mover's Distance between two distributions;
the initial parameter distribution index is calculated as follows:
$${d}_{init} = {max}_{l ∈ [ 1 , L ]} \{ EMD ( P ( {w}_{l}^{0} ) , {P}_{GMM} ( {w}_{l}^{0} ) ) \}$$
where dᵢₙᵢₜ represents the initial parameter distribution index, L represents a number of layers of the model, EMD( [symbol] ) represents an Earth Mover's Distance between the two distributions, P(·) represents a distribution of parameters, wₗ⁰ represents a parameter matrix of the l-th layer of the initial model, and P_{GMM}(·) represents the Gaussian mixture distribution;
the initial parameter randomness index is calculated by calculating a variance proportion of a maximum principal component in principal component analysis results of each layer of the initial model in the model chain to be verified; and
the model chain distance index is calculated as:
$${d}_{chain} = d ( {C}_{0} , {C}_{N} )$$
where d_{chain} represents the model chain distance index, and d(C₀, C_{N}) represents an Euclidean distance of parameters between the initial model C₀ and the converged model C_{N} in the model chain to be verified.

18. The storage medium of claim 15, wherein obtaining the ownership verification result of the DL model to be verified by determining the authenticity of the model chain to be verified comprises:
determining the authenticity of the model chain to be verified by judging whether each of the accuracy monotonicity index, the parameter distance monotonicity index, the parameter distribution continuity index, the initial parameter distribution index, the initial parameter randomness index and the model chain distance index of the model chain to be verified meets a corresponding threshold;
in response to determining any of the accuracy monotonicity index, the parameter distance monotonicity index, the parameter distribution continuity index, the initial parameter distribution index, the initial parameter randomness index and the model chain distance index is that the model chain to be verified is incoherent, determining the model chain to be verified is incoherent, and a trainer of the DL model does not have an ownership of the DL model to be verified; and
in response to determining any of the accuracy monotonicity index, the parameter distance monotonicity index, the parameter distribution continuity index, the initial parameter distribution index, the initial parameter randomness index and the model chain distance index is that the model chain to be verified is coherent, determining the model chain to be verified is coherent, and the trainer of the DL model has an ownership of the DL model to be verified.

19. The storage medium of claim 18, wherein determining the authenticity of the model chain to be verified by judging whether each of the accuracy monotonicity index, the parameter distance monotonicity index, the parameter distribution continuity index, the initial parameter distribution index, the initial parameter randomness index and the model chain distance index of the model chain to be verified meets the corresponding threshold, comprises:
in response to the accuracy monotonicity index being less than a first preset threshold, determining that the model chain to be verified is incoherent;
in response to the parameter distance monotonicity index being less than a second preset threshold, determining that the model chain to be verified is incoherent;
in response to the parameter distribution continuity index being greater than a third preset threshold, determining that the model chain to be verified is incoherent;
in response to the initial parameter distribution index being greater than a fourth preset threshold, determining that the model chain to be verified is incoherent;
calculating a fifth threshold, and in response to the initial parameter randomness index being greater than the fifth threshold, determining that the model chain to be verified is incoherent; and
calculating a sixth threshold, and in response to the model chain distance index being greater than the sixth threshold, determining that the model chain to be verified is incoherent.

20. The storage medium of claim 19, wherein calculating the fifth threshold comprises:
randomly sampling a plurality of initial models by using the Gaussian mixture distribution for random initialization, and calculating parameter randomness indexes of the plurality of initial models; and
calculating an average value and a standard deviation of the parameter randomness indexes of the plurality of initial models, and calculating the fifth threshold based on the average value and the standard deviation of the parameter randomness indexes.
